(19) United States
(12) Patent Application Publication
(10) Pub. No.: US 2009/0325396 A1
(43) Pub. Date: Dec. 31, 2009

(54) Board-To-Board Connector Pair

(75) Inventor: Ryotaro Takeuchi, Kanagawa (JP)

Correspondence Address: MOLEX INCORPORATED, 2222 WELLINGTON COURT, LISLE, IL, 60532, US

(73) Assignee: MOLEX INCORPORATED

(21) Appl. No.: 11/922,116

(22) PCT Filed: Jun. 13, 2006
(86) PCT No.: PCT/US06/23216

§ 371 Date: Sep. 3, 2009

(30) Foreign Application Priority Data
Jun. 13, 2005 (JP) 2005-172033

(51) Int. Cl. H01R 12/00

(52) U.S. Cl. 439/65

(57) ABSTRACT

Board-to-board connectors are disclosed which include an insulative housing and conductive terminals. One connector has a receiving recess and the other has an insertion projection. The insertion projection (32) has an internal contact surface, an oppositely facing external surface and a mating face generally perpendicular to the internal and external surfaces. The insertion projection is configured for insertion into the receiving recess (12) of the other connector (10). One of the connectors has a plurality of terminals with first and second oppositely facing projecting portions. The other connector has a plurality of terminals (41) disposed on the insertion projection (32d), with a portion of each of the terminals (41) extending along the internal contact surface of the insertion projection (32). The insertion projection (32) further includes a recessed portion (34) extending from the mating face and along the external surface and against which the second projecting portion (24d) comes into contact, with a step portion (34a) being formed between the recessed portion (34) and the external surface (32a).

### BACKGROUND OF THE INVENTION

1. Field of the Invention

The present invention relates to a board-to-board connector pair.

2. Description of the Related Art

Conventionally, a board-to-board connector pair is used to electrically connect two parallel circuit boards together (see, for example, Japanese Patent Application Laid-Open (kokai) No. 2004-55463). Such a board-to-board connector pair includes two connectors which are respectively attached to mutually facing surfaces of two circuit boards and project therefrom.

FIG. 6 is a cross section of such a conventional board-to-board connector pair.

In FIG. 6, reference numeral 301 denotes a first connector which is mounted on an unillustrated first circuit board, and 311 denotes a second connector which is mounted to an unillustrated second circuit board. The first connector 301 includes a plurality of first terminals 302, and the second connector 311 includes a plurality of second terminals 312. The first connector 301 and the second connector 311 are mated with and connected to each other, whereby the first circuit board and the second circuit board are connected together.

Each of the first terminals 302 has a mount projecting portion 303 which is fitted into a corresponding mount hole of the first connector 301, whereby the first terminal 302 is fixed to the first connector 301. Each of the first terminals 302 also has a tail portion 304 which is connected, through soldering, to a corresponding wiring trace formed on the surface of the first circuit board. The second connector 311 is formed through over-molding such as to partially cover the second terminals 312. Each of the second terminals 312 also has a tail portion 313 which is connected, through soldering, to a corresponding wiring trace formed on the surface of the second circuit board.

When the first connector 301 and the second connector 311 are mated together, a connection projection 306 formed at the tip end of a connection portion 305 of the first terminal 302 comes into contact with a connection recess 315 formed in a connection portion 314 of the corresponding second terminal 312, to thereby establish electrical connection between the first circuit board and the second circuit board.

Since the first terminal 302 and the second terminal 312 are locked together upon establishment of engagement between the connection projection 306 and the connection recess 315, the first connector 301 and the second connector 311 are maintained in a mated state.

However, in the conventional board-to-board connector pair, the engagement force between the connection projection 306 and the connection recess 315 is strong, and the first connector 301 and the second connector 311 are maintained in a mated state with strong force. Therefore, when the first circuit board is pulled apart from the second circuit board so as to disconnect the first circuit board from the second circuit board, the solder tail portion 304 separates from the first circuit board because of breakage of the solder layer therebetween, or the solder tail portion 313 separates from the second circuit board because of breakage of the solder layer therebetween. In the example shown in FIG. 6, the mount projecting portions 303 of the first terminals 302 are press-fitted into the respective mount holes of the first connector 301 from the side toward the first circuit board. However, in the case where the first connector 301 is configured such that the mount projecting portions 303 are press-fitted into the respective mount holes of the first connector 301 from the side opposite the first circuit board, the first terminals 302 may come off the first connector 301, or the mount projecting portions 303 of the first terminals 302 may come off the corresponding mount holes of the first connector 301.

### SUMMARY OF THE INVENTION

An object of the present invention is to solve the above-mentioned problems in the conventional board-to-board connector pair and to provide a reliable board-to-board connector pair in which generally U-shaped first terminals are mounted to a receiving recess of a first connector; second terminals are mounted to one side surface of an insertion projection of a second connector which is to be inserted into the receiving recess of the first connector; and a step is formed on the side surface of the insertion projection opposite the second terminals so as to reduce the engagement force produced between the first terminals and the second terminals when the first connector and the second connector are disengaged from each other. Thus, the connector pair enables easy disengagement of the first connector and the second connector from each other, and also prevents exfoliation of plating layers of the first terminals and separation of solder tail portions from the circuit board because of breakage of the solder layers therebetween, which exfoliation and separation would otherwise occur when the first connector and the second connector are disengaged from each other.

To achieve the above object, the present invention provides a board-to-board connector pair comprising a first connector including first terminals disposed in a receiving recess of the first connector; and a second connector adapted to be mated with the first connector and including second terminals disposed on an insertion projection of the second connector, the insertion projection being inserted into the receiving recess of the first connector. Each of the first terminals includes a generally U-shaped first connection portion having a first projecting portion provided on a first vertical portion of the first connection portion corresponding to one side wall of the receiving recess, and a second projecting portion provided on a second vertical portion of the first connection portion corresponding to the other side wall of the receiving recess. Each of the second terminals is disposed on a first side surface of the insertion projection and includes an engagement recess portion for engaging with the first projection portion, the engagement recess portion extending along an insertion direction of the insertion projection. The insertion projection includes a recessed portion formed at a distal end portion of a second side surface, which is opposite the first side surface of the insertion projection and with which the second projecting portion comes into contact, with a step portion being formed between the recessed portion and the remaining portion of the second side surface.

Preferably, the first projecting portion and the second projecting portion are located at the same position with respect to the insertion direction of the insertion projection, and the step portion is located rearward of the front end of the engagement recess portion with respect to the insertion direction of the insertion projection.

Preferably, when the insertion projection is inserted into the receiving recess, the first connection portion is elastically deformed and expanded to nip the insertion projection between the first projecting portion and the second projecting portion.

Preferably, the first connector includes grooves for receiving the first terminals, and the first terminals are pressed-fitted into the grooves in the insertion direction of the insertion projection.

Preferably, each of the first terminals includes a fixation portion and a solder tail portion, which project in the insertion direction of the insertion projection from the second vertical portion of the first connection portion, on which the second projection portion is provided, and the first terminal is fixed to the first connector by means of the fixation portion and the solder tail portion.

In the board-to-board connector pair according to the present invention, generally U-shaped first terminals are mounted to a receiving recess of a first connector; second terminals are mounted to one side surface of an insertion projection of a second connector which is to be inserted into the receiving recess of the first connector; and a step is formed on the side surface of the insertion projection opposite the second terminals so as to reduce the engagement force produced between the first terminals and the second terminals when the first connector and the second connector are disengaged from each other. Thus, the connector pair enables easy disengagement of the first connector and the second connector from each other, and also prevents exfoliation of plating layers of the first terminals and separation of solder tail portions from the circuit board because of breakage of the solder layers therebetween, which exfoliation and separation would otherwise occur when the first connector and the second connector are disengaged from each other, whereby the reliability can be enhanced.

### BRIEF DESCRIPTION OF THE DRAWINGS

FIG. 1 is a sectional view of first and second connectors according to an embodiment of the present invention, showing a state in which the connectors are mated together;

FIG. 2 is a perspective view of the first connector according to the embodiment of the present invention;

FIG. 3 is a perspective view of the second connector according to the embodiment of the present invention;

FIG. 4 is an enlarged view of a main portion of the second connector according to the embodiment of the present invention, showing the portion A of FIG. 3;

FIG. 5 is a sectional view of the first and second connectors according to the embodiment of the present invention, showing a state in which the first and second connectors are in the middle of disengagement operation; and

FIG. 6 is a sectional view of a conventional board-to-board connector pair.

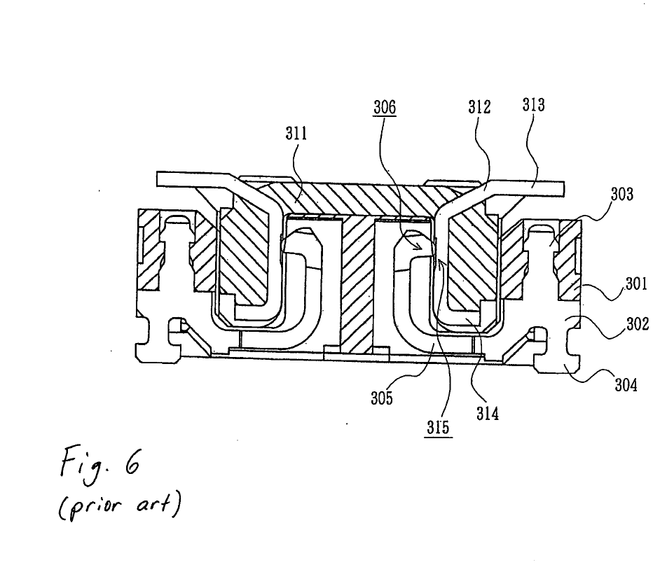

### DETAILED DESCRIPTION OF THE PREFERRED EMBODIMENT

An embodiment of the present invention will next be described in detail with reference to the drawings.

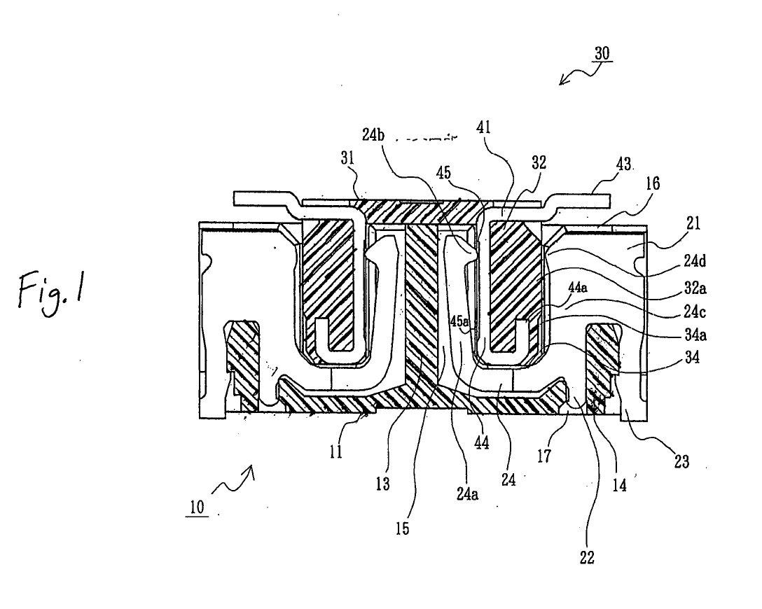

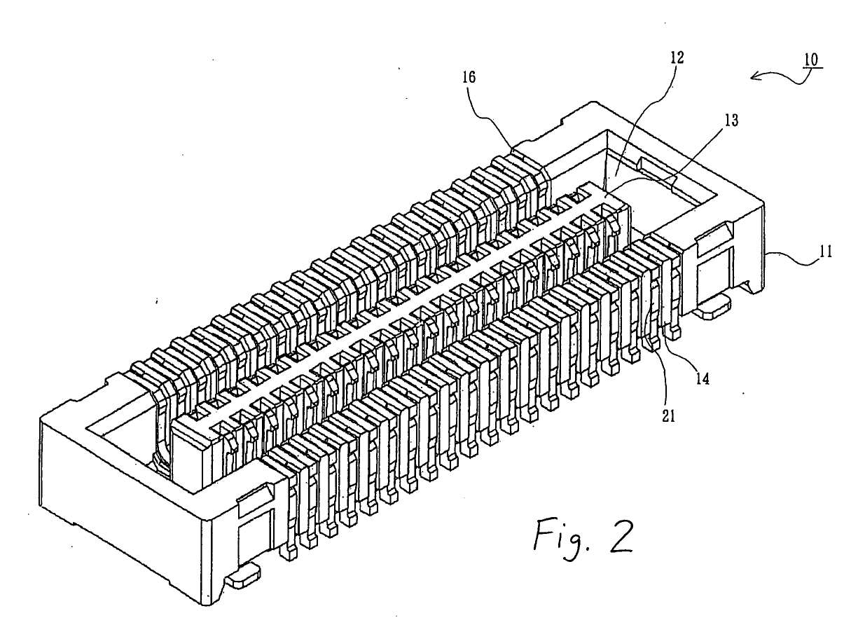

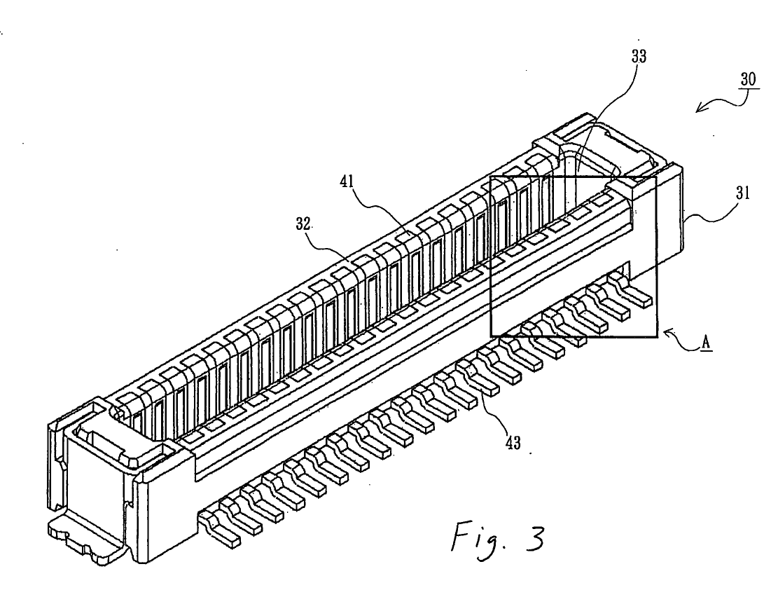

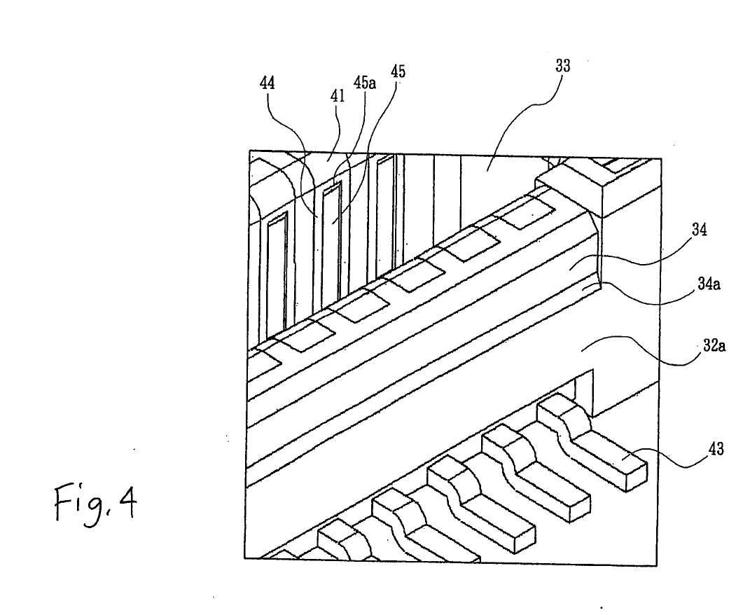

FIG. 1 is a sectional view of first and second connectors according to the embodiment of the present invention, showing a state in which the connectors are mated together; FIG. 2 is a perspective view of the first connector according to the embodiment of the present invention; FIG. 3 is a perspective view of the second connector according to the embodiment of the present invention; and FIG. 4 is an enlarged view of a main portion of the second connector according to the embodiment of the present invention, showing the portion A of FIG. 3.

In these drawings, reference numeral 10 denotes a first connector, which is one of paired board-to-board connectors according to the present embodiment and which is a surface-mount-type connector to be mounted on the surface of one circuit board. Reference numeral 30 denotes a second connector, which is the other of the paired board-to-board connectors according to the present embodiment and which is a surface-mount-type connector to be mounted on the surface of another circuit board. The paired board-to-board connectors (i.e., a board-to-board connector pair) according to the present embodiment include the first connector 10 and the second connector 30 and electrically connect a pair of circuit boards. Although the circuit boards are printed circuit boards (PCBs), the circuit boards can be of any type.

In the present embodiment, terms for expressing direction, such as up, down, left, right, front, and rear, are used for explaining the structure and action of respective portions of the board-to-board connectors; however, these terms represent respective directions for the case where the board-to-board connectors are used in an orientation shown in the drawings, and must be construed to represent corresponding different directions when the orientation of the board-to-board connectors is changed.

The first connector 10 includes a first housing (connector main body) 11 integrally formed from an insulative material such as a synthetic resin. As shown in FIG. 2, the first housing 11 has a shape of a generally rectangular thick plate, and a generally rectangular concave portion is formed on an upper surface of the first housing 11. The first connector 10 has a size of about 12 mm (length)×about 3.5 mm (width)×about 1.7 mm (thickness); however, the size can be changed freely. In the concave portion, a ridge portion 13 is formed integrally with the first housing 11. Further, side wall portions 14 extending parallel to the ridge portion 13 are formed integrally with the first housing 11 such that the side wall portions 14 are located on the opposite sides of the ridge portion 13. In this case, the ridge portion 13 and the side wall portions 14 project upward from the bottom surface of the concave portion and extend along the longitudinal direction of the first housing 11. Thus, an elongated groove portion 12 (a receiving recess) extending along the longitudinal direction of the first housing 11 is formed on either side of the ridge portion 13 to be located between the ridge portion 13 and the corresponding side wall portion 14. In the illustrated example, only one ridge portion 13 is provided; however, a plurality of ridge portions may be provided, and the number of the ridge portions is arbitrary. Although the ridge portion 13 has a width of about 0.8 mm, the size may be changed freely.

First-terminal accommodation cavities (grooves) 15 for accommodating first terminals 21 are formed such that they extend along the opposite side surfaces of the ridge portion 13 and the bottom surfaces of the groove portions 12. Specifically, twenty first-terminal accommodation cavities 15 are formed on each of the side surfaces of the ridge portion 13 and on the bottom surface of the corresponding groove portion 12 at a pitch of about 0.4 mm. Thus, twenty first terminals 21, which are accommodated within the twenty first-terminal accommodation cavities 15, are disposed on each of the side surfaces of the ridge portion 13 and the bottom surface of the corresponding groove portion 12 at a pitch of about 0.4 mm. Further, first-terminal accommodation grooves 16 are formed on the distal end surfaces (i.e., the upper surfaces in FIG. 2) of the side wall portions 14 at positions corresponding to those of the first-terminal accommodation cavities 15. The first-terminal accommodation cavities 15 and the first-terminal accommodation grooves 16 are continuously and integrally formed and serve as grooves for accommodating the first terminals 21. First-terminal fixation holes 17 are formed such as to be in communication with the first terminal accommodating cavities 15 and vertically penetrate the respective side wall portions 14. Notably, the pitches and numbers of the first-terminal accommodation cavities 15, the first-terminal accommodation grooves 16, the first-terminal fixation holes 17, and the first terminals 21 can be changed freely.

Next, the structure of the first terminals 21 will be described.

As shown in FIG. 1, each of the first terminals 21 has a fixing portion 22, a solder tail portion 23, and a first connection portion 24, and is integrally formed from an electrically conductive metal sheet through punching.

The first connection portion 24 has a generally U-shaped profile, and has a front side wall portion 24a (a side wall portion located near the distal end), which extends in the vertical direction and which is accommodated in the first-terminal accommodation cavity 15 formed on the corresponding side surface of the ridge portion 13, and a rear side wall portion 24c (a side wall portion located near the solder tail portion 23), which extends in the vertical direction. The rear side wall portion 24c and the main body of the first terminal 21 are integrally formed. A bottom portion between the front side wall portion 24a and the rear side wall portion 24c; i.e., a portion corresponding to the horizontal portion of the letter U, extends in the lateral direction and is accommodated in the first-terminal accommodation cavity 15 formed on the bottom surface of the corresponding groove portion 12. A first projecting portion 24b is formed in the vicinity of the upper end of the front side wall portion 24a, and a second projecting portion 24d is formed in the vicinity of the upper end of the rear side wall portion 24c. The first and second projecting portions 24b and 24d project such that they face each other. The first and second projecting portions 24b and 24d are located at substantially the same position in the insertion direction of the ridge portion 32 (insertion projection); i.e., the vertical direction in FIG. 1. The first projecting portion 24b extends out of the first-terminal accommodation cavity 15 and is located within the groove portion 12. The rear side wall portion 24c is located within the first-terminal accommodation cavity 15.

The first connection portion 24 has a spring property, because mainly the front side wall portion 24a and the bottom portion deform elastically. Therefore, when the first connector 10 is mated with the second connector 30 and the first projecting portion 24b is thus pushed toward the ridge portion 13 by a second connection portion 44 of the second terminal 41, the first connection portion 24 reacts by virtue of its spring property, so that the first projecting portion 24b and the second projecting portion 24d nip the ridge portion 32 to which the second terminals 41 are mounted. Thus, electrical connection between each first terminal 21 and the corresponding second terminal 41 can be maintained without fail.

Further, the main body of the first terminal 21 has an inverted U-shaped side shape and is accommodated within the corresponding first-terminal accommodation groove 16 formed on the upper surface of the side wall portion 14. The rear side wall portion 24c of the first connection portion 24 is integrally connected to an inner end (end located on the side toward the ridge portion 13) of the main body. The fixing portion 22 projects from the bottom of the rear side wall portion 24c in the direction along which the ridge portion 32 (insertion projection) is inserted. The fixing portion 22 is inserted to the corresponding first-terminal fixation hole 17 of the first housing 11. The solder tail portion 23 is connected to an outer end (end located on the side opposite the ridge portion 13) of the main body. The solder tail portion 23 projects in the insertion direction of the ridge portion 32 (insertion projection), and the projection end surface (the lower end surface) of the solder tail portion 23 is soldered to a wiring land formed on the surface of an unillustrated circuit board. In this case, a path along the first terminal 21 extending from the lower end surface of the solder tail portion 23 to the first projecting portion 24b is long, and bent in a complex manner. Therefore, the phenomenon of solder rising does not occur. That is, there is no possibility that solder adheres to the first projecting portion 24b.

Moreover, if necessary, an unillustrated solder barrier portion may be formed in the middle of the path extending from the solder tail portion 23 to the first projecting portion 24b. An example of the solder barrier portion is a nickel (Ni) coating layer formed through plating. However, a coating layer of any type may be used, so long as solder substantially does not adhere to the coating layer, and no limitation is imposed on the method of forming the coating layer.

Each first terminal 21 is fitted from above in FIG. 1 into the corresponding first-terminal accommodation cavity 15 and the corresponding first-terminal accommodation groove 16 so that the fixing portion 22 and the solder tail portion 23 nip the side wall portion 14. Thus, the first terminal 21 is fixed in the first housing 11. As shown in FIG. 1, an engagement portion is formed on the inner side surface of the solder tail portion 23, and an engagement portion to be engaged with the engagement portion of the solder tail portion 23 is formed on the outer side surface of the side wall portion 14. When the first terminal 21 is inserted from above so that the fixing portion 22 and the solder tail portion 23 nip the side wall portion 14, as shown in FIG. 1, the engagement portion of the solder tail portion 23 and the engagement portion of the side wall portion 14 are mated together. Therefore, the first terminal 21 is prevented from coming off the first housing 11. Thus, the first terminal 21 is fixed to the first connector 10.

In order to improve adhesion of solder, a gold (Au) coating layer is preferably formed on the lower end surface of the solder tail portion 23 through plating. Further, in order to lower electrical contact resistance, a gold (Au) coating layer is preferably formed on the front surface of the first projecting portion 24b through plating.

Next, the structure of the second connector 30 will be described.

The second connector 30 includes a second housing (connector main body) 31 integrally formed from an insulative material such as a synthetic resin. As shown in FIG. 3, the second housing 31 has a shape of a generally rectangular thick plate. The second housing 31 has a size of about 10 mm (length)×about 3 mm (width)×about 1.1 mm (thickness); however, the size can be changed freely. On the upper surface of the second housing 31 in FIG. 3, two ridge portions (insertion projections) 32 extending in the longitudinal direction are formed integrally with the second housing 31. The ridge portions 32 are formed along the opposite lateral sides of the second housing 31. Further, an elongated groove portion 33 extending in the longitudinal direction of the second housing 31 is formed between the two ridge portions 32. Notably, in the illustrated example, the number of the ridge portions 32 is two; however, a single ridge portion or three or more ridge portions may be provided, and the number of the ridge portions is arbitrary. Although each of the ridge portions 33 has a width of about 0.8 mm, the size may be changed freely.

The second housing 31 is formed through over-molding such as to partially cover the second terminals 41. The second connection portion 44 of each second terminal 41 is embedded in the ridge portion 32 such that, as shown in FIG. 4, the surface of the second connection portion 44 is exposed at the inner side surface and the distal end surface (top surface in FIGS. 3 and 4) of the ridge portion 32. Each of the second terminals 41 has a solder tail portion 43 extending outward from the lower edge of one of the opposite sides of the second housing 31. In this case, twenty second terminals 41 are disposed at a pitch of about 0.4 mm on each side. The pitch and the number of the second terminals 41 may be changed as desired.

Next, the structure of the second terminals 41 will be described.

As shown in FIG. 1, each of the second terminals 41 has a solder tail portion 43 and a second connection portion 44, and is integrally formed from an electrically conductive metal sheet through punching.

The second connection portion 44 has a generally J-shaped profile, and has a vertically extending side wall portion having a surface exposed at the inner side surface of the ridge portion 32 and a vertically extending distal end portion 44a which is embedded in the ridge portion 32. Since the distal end portion 44a is embedded in the ridge portion 32, the second terminal 41 is strongly secured to the second housing 31. A bottom portion between the side wall portion and the distal end portion 44a; i.e., a portion corresponding to the lower horizontal portion of the letter J, extends in the lateral direction and is exposed at the distal end surface of the ridge portion 32. The inner end (end on the side toward the groove portion 33) of the solder tail portion 43 is connected to the upper end of the second connection portion 44, and extends in the lateral direction. The upper surface (in FIG. 1; i.e., the lower surface in FIGS. 3 and 4) of the solder tail portion 43 is soldered to a wiring land formed on the surface of an unillustrated circuit board.

An engagement portion (engagement recess portion) 45 is formed on the surface of the side wall portion of the second connection portion 44, and comes into engagement with the first projecting portion 24b of the corresponding first terminal 21. The engagement portion 45 is a recess portion which extends in the insertion direction of the ridge portion (insertion projection) 32; i.e., in the vertical direction in FIG. 1, and comes into engagement with the first projecting portion 24b. When the first connector 10 is mated with the second connector 30, since the first projecting portion 24b enters and engages with the recess of the engagement portion 45, the connection between the first terminal 21 and the second terminal 41 is reliably maintained, whereby disengagement of the first connector 10 from the second connector 30 can be prevented. Notably, the second projecting portion 24d of the first terminal 21 comes into contact with a flat outer side surface 32a of the ridge portion 32.

The vertically extending recess of the engagement portion 45 enables the first projecting portion 24b to continuously wipe the surface of the engagement portion 45, to thereby produce a sufficient level of wiping effect. Thus, the electrical connection between the first projecting portion 24b and the second connection portion 44 is ensured. In addition, since the first projecting portion 24b comes into engagement with an engagement end 45a of the engagement portion 45; i.e., a distal-side end portion (the lower end in FIG. 1) of the engagement portion 45, disengagement of the first connector 10 from the second connector 30 can be prevented.

A recessed portion 34 is formed at a distal portion of the side surface 32a of the ridge portion 32, with the step portion 34a formed between the recessed portion 34 and the remaining portion of the side surface 32a. In this case, as compared with the engagement end 45a of the engagement portion 45, the step portion 34a is separated further from the distal end of the ridge portion 32; i.e., is closer to the solder tail portion 43. The vertical distance between the step portion 34a and the engagement end 45a is about 0.2 mm. However, the vertical distance may be determined arbitrarily. This structure allows, when the first connector 10 is disengaged from the second connector 30, the second projecting portion 24d in contact with the side surface 32a of the ridge portion 32 to move to the recessed portion 34 while passing through the step portion 34a. Thus, the contact pressure produced between the ridge portion 32 and the second projecting portion 24d is reduced, and accordingly, the contact pressure produced between the first projecting portion 24b and the second connection portion 44 is reduced. Thus, the first projecting portion 24b is readily disengaged from the engagement end 45a of the engagement portion 45.

In order to improve adhesion of solder, a gold (Au) coating layer is preferably formed on the top surface of the solder tail portion 43 through plating. Further, in order to reduce electrical contact resistance, a gold (Au) coating layer is preferably formed on the surface of the engagement portion 45 of the second connection portion 44 through plating. Since the second housing 31 is formed through over-molding such as to cover the connection portion between the solder tail portion 43 and the second connection portion 44, there is prevented occurrence of the phenomenon in which solder ascends along the second terminal 41 and adheres to the surface of the side wall portion of the second connection portion 44 when the solder tail portion 43 is soldered to a wiring land of a circuit board.

Next, operation of mating the first connector 10 and the second connector 30 with each other and operation of disengaging the first connector 10 and the second connector 30 from each other will be described.

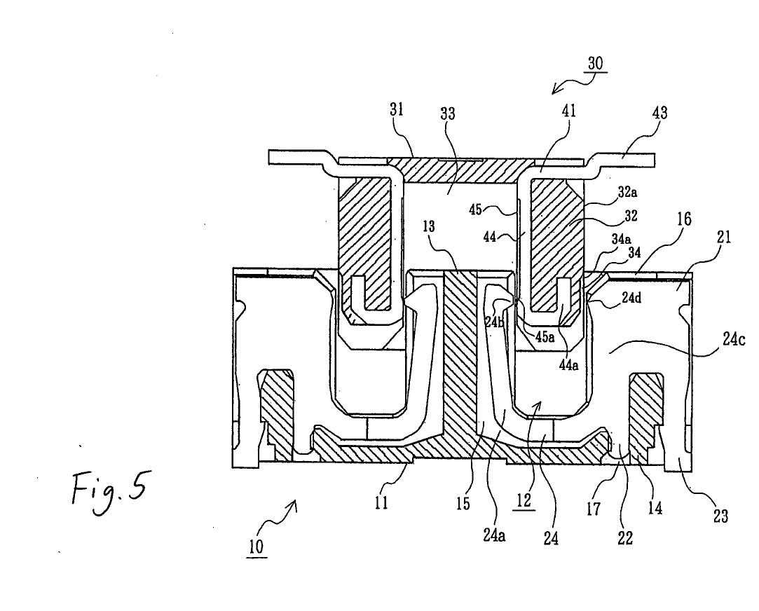

FIG. 5 is a cross sectional view showing a state in which the first and second connectors according to the embodiment of the present invention are in the middle of disengagement operation.

Here, the first connector 10 is assumed to have been surface-mounted onto an unillustrated circuit board by means of soldering the solder tail portions 23 of the first terminals 21 to corresponding wiring lands of the circuit board. Similarly, the second connector 30 is assumed to have been surface-mounted onto a second circuit board by means of soldering the solder tail portions 43 of the second terminals 41 to corresponding wiring lands of the second circuit board.

The first connector 10 and the second connector 30 are held such that the upper surface of the first connector 10 and the upper surface of the second connector 30 face each other. In this state, the upper surface of the first connector 10 and the upper surface of the second connector 30 are generally parallel to each other, and the boards carrying the first connector 10 and the second connector 30, respectively, are also generally parallel to each other.

Subsequently, the first connector 10 and the second connector 30 are moved toward each other, or one of the first connector 10 and the second connector 30 is moved toward the other connector, whereby they are mated with each other as shown in FIG. 1. Notably, in FIG. 1, circuit boards are omitted in order to simplify the illustration. In the state in which the first connector 10 and the second connector 30 are mated with each other, the ridge portion 13 of the first connector 10 is inserted into the groove portion 33 of the second connector 30, and the ridge portions 32 of the second connector 30 are inserted into the corresponding groove portions 12 of the first connector 10.

As a result, the first projecting portion 24b of the first connection portion 24 of each first terminal 21 comes into contact with the engagement portion 45 of the second connection portion 44 of the corresponding second terminal 41. Further, the second projecting portion 24d of the first connection portion 24 of each first terminal 21 engages the flat side surface 32a of the ridge portion 32. (Notably, FIG. 1 is depicted such that a gap is present between the second projecting portion 24d and the side surface 32a, for the sake of clarity). That is, each first terminal 21 and the corresponding second terminal 41 electrically communicate with each other via a contract point at which the first projecting portion 24b comes into contact with the engagement portion 45 of the second connection portion 44.

In the present embodiment, the distance between the facing surfaces of the first and second projecting portions 24b and 24d of the first connection portion 24 of each first terminal 21 is shorter than the distance between the engagement portion 45 of the second connection portion 44 of each second terminal 41 and the side surface 32a of the ridge portion 32. The first connection portion 24 has a spring property. Therefore, when, as a result of mating of the first connector 10 and the second connector 30 together, the ridge portions 32 of the second connector 30 are inserted into the corresponding groove portions 12 of the first connector 10, the distance between the facing surfaces of the first and second projecting portions 24b and 24d of the first connection portion 24 of the first terminal 21 increases, and mainly the front side wall portion 24a and the bottom portion elastically deform, whereby the first projecting portion 24b is pushed by the engagement portion 45 of the second connection portion 44 of the second terminal 41 and moves toward the ridge portion 13. In this case, by virtue of its spring property, the first connection portion 24 reacts to restore its original shape. Therefore, the ridge portion 32 to which the second terminals 41 are mounted is nipped by the first projecting portion 24b of the front side wall portion 24a and the second projecting portion 24d of the rear side wall portion 24c.

As a result, the end of the first projecting portion 24b of each first terminal 21 is pressed against the engagement portion 45 of the second connection portion 44 of the corresponding second terminal 41. Thus, reliable electrical continuity is established between the first projecting portion 24b and the second connection portion 44, and electrical continuity at the contact portion is secured.

Further, when each of the ridge portions 32 of the second connector 30 is inserted into the corresponding groove portion 12 of the first connector 10, the tip portion of the first projecting portion 24b of the first terminal 21 moves while scrubbing the flat surface of the engagement portion 45 in a state in which the tip portion is pushed against the engagement portion 45 of the second connection portion 44 of the second terminal 41. Therefore, a scraping effect or wiping effect is produced, so that substances which hinder electrical continuity, such as dust adhering to the tip end of the first projection portion 24b and the surface of the engagement portion 45, are removed through wiping. Therefore, reliable electrical continuity is secured at the contact portion.

Next, operation of disengaging the first connector 10 and the second connector 30 from each other will be described.

In this operation, the first connector 10 and the second connector 30, which have been in a state shown in FIG. 1, are pulled away from each other. As a result, the ridge portions 32 of the second connector 30 are pulled upward from the respective groove portions 12 of the first connector 10, while being nipped by the first projecting portion 24b and the second projecting portion 24d of the first connection portion 24 of each first terminal connector 21. Accordingly, the first projecting portion 24b is moved toward the distal end of the ridge portion 32 along the engagement portion 45 of the second connection portion 44 of the second connector 41, and the second projecting portion 24d is moved toward the distal end of the ridge portion 32 along the side surface 32a of the ridge portion 32.

Subsequently, the second projecting portion 24d passes through the step portion 34a of the ridge portion 32 and reaches the recessed portion 34, as shown in FIG. 5. The distance between the engagement portion 45 of the second connection portion 44 of the second terminal 41 and the recessed portion 34 of the ridge portion 32 is shorter than the distance between the engagement portion 45 and the side surface 32a of the ridge portion 32. Therefore, the contact pressure between the ridge portion 32 and the second projecting portion 24d is lowered, whereby the contact pressure between the first projecting portion 24b and the second connection portion 44 is lowered accordingly. Therefore, the first projecting portion 24b easily passes over the engagement end 45a of the engagement portion 45 of the second connection portion 44; i.e., the first projecting portion 24b easily disengages from the engagement end 45a, so that the first connector 10 and the second connector 30 can be disengaged from each other without application of large force.

As described above, in the present embodiment, the first terminals 21 each having the generally U-shaped first connection portion 24 are attached to the first connector 10, and the ridge portions 32 of the second connector 30, in which the second connection portions 44 of the second terminals 41 are embedded, are fitted into the first connection portions 24. The step portion 34a is formed on the side surface 32a of each of the ridge portions 32 in order to reduce the engagement force which is produced between the first projecting portion 24b of each first terminal 21 and the engagement portion 45 of the second connection portion 44 of the corresponding second terminal 41 when the first connector 10 and the second connector 30 are disengaged from each other.

Therefore, the first connector 10 and the second connector 30 can readily be disengaged from each other. Further, since the first projecting portion 24b easily disengages from the engagement end 45a during the disengagement operation, the first projecting portion 24b is prevented from being pulled upward while being caught by the corresponding engagement end 45a, whereby exfoliation of the plating layer of the first connection portion 24 is prevented. Moreover, separation of the solder tail portions 23 of the first terminals 21 from the corresponding circuit board at the solder portion therebetween is prevented, and separation of the solder tail portions 43 of the second terminals 41 from the corresponding circuit board at the solder portion therebetween is prevented. Therefore, a reliable board-to board connector pair can be obtained.

More specifically, when the first connector 10 and the second connector 30 are mated with each other, and each of the ridge portions 32 of the second connector 30 is inserted into the corresponding groove portion 12 of the first connector 10, the ridge portion 32 to which the second terminal 41 is mounted is nipped between the first projecting portion 24b and the second projecting portion 24d of each first terminal 21. Therefore, the tip end of the first projecting portion 24b of the first terminal 21 is pressed against the engagement portion 45 of the second connection portion 44 of the corresponding second terminal 41, so that reliable contact is established between the first projecting portion 24b and the second connection portion 44, whereby reliable electrical continuity is attached at the contact portion. In addition, since the contact pressure between the first projecting portion 24b and the engagement portion 45 is not transmitted to the solder tail portion 23, when the first connector 10 and the second connector 30 are mated with to each other, no force is applied to the solder portion between the solder tail portion 23 and the circuit board, causing no occurrence of cracks at the solder portion.

Moreover, the engagement portion 45 of the second connection portion 44 of each of the second terminals 41 includes a recess, and, when the first connector 10 is mated with the second connector 30, the first projecting portion 24b of each first terminal 21 enters and comes into engagement with the recess of the engagement portion 45. Thus, reliable contact is maintained between the first terminal 21 and the corresponding second terminal 41, and disengagement of the first connector 10 from the second connector 30 can be prevented. In addition, when the first connector 10 is mated with the second connector 30, the operator can obtain a good click sensation.

At a distal portion of the side surface 32a of each of the ridge portions 32 of the second connector 30, the recessed portion 34 is formed with the step portion 34a formed between the recessed portion 34 and the remaining portion of the side surface 32a. Therefore, when the second projecting portion 24d of the first terminal 21, the projecting portion 24d having been in contact with the side surface 32a of the ridge portion 32, passes over the step portion 34a and reaches the recessed portion 34 during an operation of disengaging the first connector 10 and the second connector 30 from each other, the contact pressure between the ridge portion 32 and the second projecting portion 24d is lowered, whereby the contact pressure between the first projecting portion 24b and the second connection portion 44 is lowered. Thus, the first projecting portion 24b easily disengages from the engagement end 45a of the engagement portion 45. Therefore, the first projecting portion 24b is prevented from being pulled upward while being caught by the corresponding engagement end 45a, whereby exfoliation of the plating layer of the first connection portion 24 is prevented. In addition, the first terminal 21 is prevented from coming off the corresponding side wall portion 14. Further, no force is applied to the solder portions between the solder tail portions 23 of the first terminals 21 and the corresponding circuit board and to the solder portions between the solder tail portions 43 of the second terminals 41 and the corresponding circuit board.

The present invention is not limited to the above-described embodiments. Numerous modifications and variations of the present invention are possible in light of the spirit of the present invention, and they are not excluded from the scope of the present invention.

1. A board-to-board connector for mating with a complimentary connector, said complimentary connector having an insulative housing with a receiving recess, and complimentary terminals disposed in terminal recesses in the housing of the complimentary connector, said complimentary terminals having first and second oppositely facing projecting portions, said board-to-board connector comprising:
an insulative connector housing with an insertion projection, the insertion projection having an internal contact surface, an oppositely facing external surface and a mating face generally perpendicular to said internal and external surfaces, said insertion projection being configured for insertion into the receiving recess of the complimentary connector;
a plurality of terminals disposed on said insertion projection, a portion of each of the terminals extending along said internal contact surface of the insertion projection; and
wherein said insertion projection further includes a recessed portion extending from said mating face and along said external surface and against which the second projecting portion comes into contact, with a step portion being formed between the recessed portion and the external surface.

2. The board-to-board connector of claim 1, wherein the step portion is spaced from said mating face with respect to an insertion direction of the insertion projection.

3. The board-to-board connector of claim 2, wherein upon insertion of the insertion projection into the receiving recess, the first connection portion is elastically deformed and said board-to-board connector is engaged between the first and second projecting portions.

4. A board-to-board connector pair comprising:
a first connector including first terminals disposed in a receiving recess of the first connector; and
a second connector adapted to be mated with the first connector and including second terminals disposed on an insertion projection of the second connector, the insertion projection being inserted into the receiving recess of the first connector, wherein
each of the first terminals includes a generally U-shaped first connection portion having a first projecting portion provided on a first vertical portion of the first connection portion corresponding to one side wall of the receiving recess, and a second projecting portion provided on a second vertical portion of the first connection portion corresponding to the other side wall of the receiving recess;
each of the second terminals is disposed on a first side surface of the insertion projection and includes an engagement recess portion for engaging with the first projection portion, the engagement recess portion extending along an insertion direction of the insertion projection; and
the insertion projection includes a recessed portion formed at a distal end portion of a second side surface, which is opposite the first side surface of the insertion projection and with which the second projecting portion comes into contact, with a step portion being formed between the recessed portion and the remaining portion of the second side surface.

5. The board-to-board connector pair of claim 4, wherein
the first projecting portion and the second projecting portion are located at the same position with respect to the insertion direction of the insertion projection; and
the step portion is located rearward of the front end of the engagement recess portion with respect to the insertion direction of the insertion projection.

6. The board-to-board connector pair of claim 5, wherein when the insertion projection is inserted into the receiving recess, the first connection portion is elastically deformed and expanded to nip the insertion projection between the first projecting portion and the second projecting portion.

7. The board-to-board connector pair of claim 4, wherein
the first connector includes grooves for receiving the first terminals; and
the first terminals are pressed-fitted into the grooves in the insertion direction of the insertion projection.

8. The board-to-board connector pair of claim 7, wherein each of the first terminals includes a fixation portion and a solder tail portion which project in the insertion direction of the insertion projection from the second vertical portion of the first connection portion, on which the second projection portion is provided, and the first terminal is fixed to the first connector by means of the fixation portion and the solder tail portion.
